(19) United States
(12) Patent Application Publication
(10) Pub. No.: US 2016/0057671 A1
(43) Pub. Date: Feb. 25, 2016

(54) FAST RETURN AFTER CIRCUIT SWITCHED FALL BACK (CSFB) CALL RELEASE

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/465,998

(22) Filed: Aug. 22, 2014

(51) Int. Cl. H04W 36/08; H04W 36/00; H04W 36/30

(52) U.S. Cl. CPC H04W 36/08; H04W 36/30; H04W 36/0022

(57) ABSTRACT

A user equipment (UE) reduces delays associated with returning to a first radio access technology (RAT) after redirection to a second RAT. The UE moves from a first radio access technology (RAT) to a second RAT to permit a circuit switched (CS) call. When the UE fails to return to the first RAT after releasing the circuit switched call on the second RAT, the UE establishes a first packet switched (PS) call on the second RAT. The first packet switched call may be triggered by a background application. The UE periodically suspends communications during the first packet switched call on the second RAT. The UE creates a forced measurement gap during suspension of the first packet switched call in the second RAT to monitor the first RAT and returns to the first RAT to resume the first packet switched call when the monitoring detects a cell in the first RAT.

### BACKGROUND

1. Field

Aspects of the present disclosure relate generally to wireless communication systems, and more particularly, to fast return to a first radio access technology (RAT) network after a circuit switched call back (CSFB) call is released from a second RAT network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes moving from a first radio access technology (RAT) to a second RAT to permit a circuit switched (CS) call. The method also includes failing to return to the first RAT after releasing the circuit switched call on the second RAT. The method also includes establishing a first packet switched (PS) call on the second RAT. The first packet switched call may be triggered by a background application. The method further includes periodically suspending communications during the first packet switched call on the second RAT. The method includes creating a forced measurement gap during suspending of the first packet switched call in the second RAT to monitor the first RAT. The method also includes returning to the first RAT to resume the first packet switched call when monitoring detects a cell in the first RAT.

According to another aspect of the present disclosure, an apparatus for wireless communication includes means for moving from a first radio access technology (RAT) to a second RAT to permit a circuit switched (CS) call. The apparatus may also include means for failing to return to the first RAT after releasing the circuit switched call on the second RAT. The apparatus may also include means for establishing a first packet switched (PS) call on the second RAT. The first packet switched call may be triggered by a background application. The apparatus further includes means for periodically suspending communications during the first packet switched call on the second RAT. The apparatus further includes means for creating a forced measurement gap during suspending of the first packet switched call in the second RAT to monitor the first RAT. The apparatus further includes means for returning to the first RAT to resume the first packet switched call when monitoring detects a cell in the first RAT.

Another aspect discloses a computer program product for wireless communications in a wireless network having a non-transitory computer-readable medium. The computer readable medium has non-transitory program code recorded thereon which, when executed by the processor(s), causes the processor(s) to perform an operation of moving from a first radio access technology (RAT) to a second RAT to permit a circuit switched (CS) call. The program code also causes the processor(s) to fail to return to the first RAT after releasing the circuit switched call on the second RAT. The program code also causes the processor(s) to establish a first packet switched (PS) call on the second RAT. The first packet switched call may be triggered by a background application. The program code further causes the processor(s) to periodically suspend communications during the first packet switched call on the second RAT. The program code further causes the processor(s) to create a forced measurement gap during suspending of the first packet switched call in the second RAT to monitor the first RAT. The program code further causes the processor(s) to return to the first RAT to resume the first packet switched call when monitoring detects a cell in the first RAT.

Another aspect discloses an apparatus for wireless communication and includes a memory and at least one processor coupled to the memory. The processor(s) is configured to move from a first radio access technology (RAT) to a second RAT to permit a circuit switched (CS) call. The processor(s) is also configured to fail to return to the first RAT after releasing the circuit switched call on the second RAT. The processor(s) is also configured to establish a first packet switched (PS) call on the second RAT. The first packet switched call may be triggered by a background application. The processor(s) is further configured to periodically suspend communications during the first packet switched call on the second RAT. The processor(s) is further configured to create a forced measurement gap during suspending of the first packet switched call in the second RAT to monitor the first RAT. The processor(s) is further configured to return to the first RAT to resume the first packet switched call when monitoring detects a cell in the first RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a method for wireless communication according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

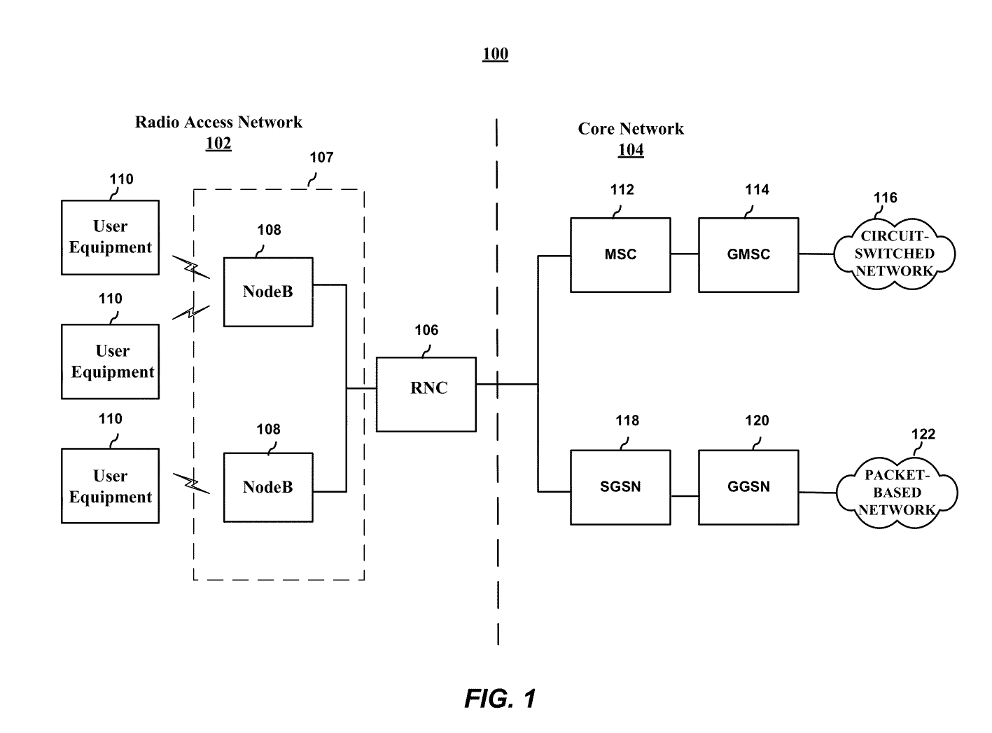

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

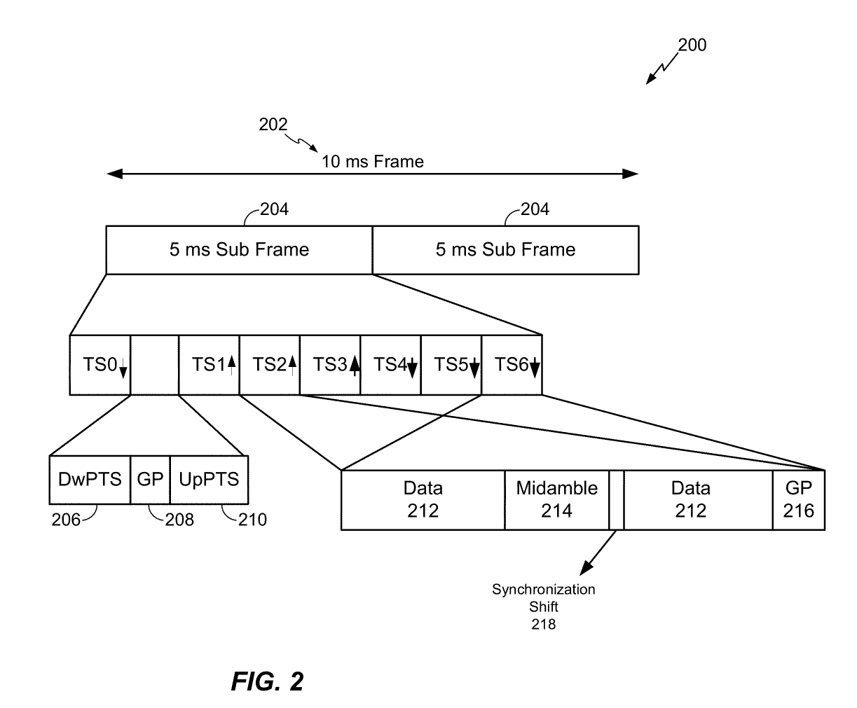

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TSO-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

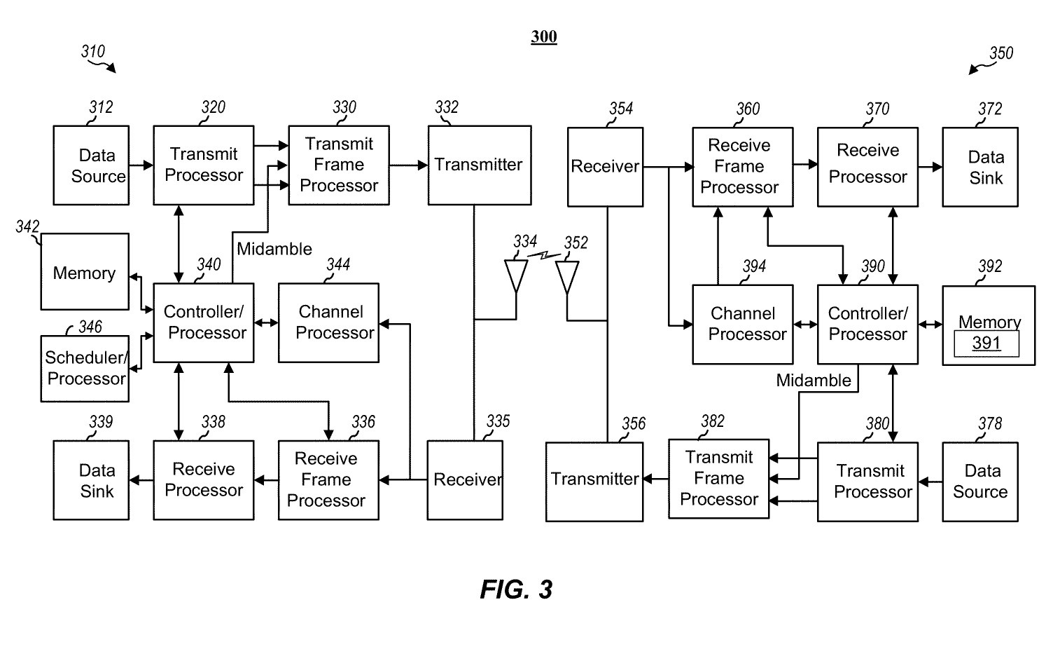

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store redirection return module 391 which, when executed by the controller/processor 390, configures the UE 350 for reducing delays associated with returning to a first radio access technology (RAT) after redirection to a second RAT, according to aspects of the present disclosure. A scheduler/processor 346 at the node B 310 may be used to allocate resources to the UEs and schedule downlink and/or uplink transmissions for the UEs.

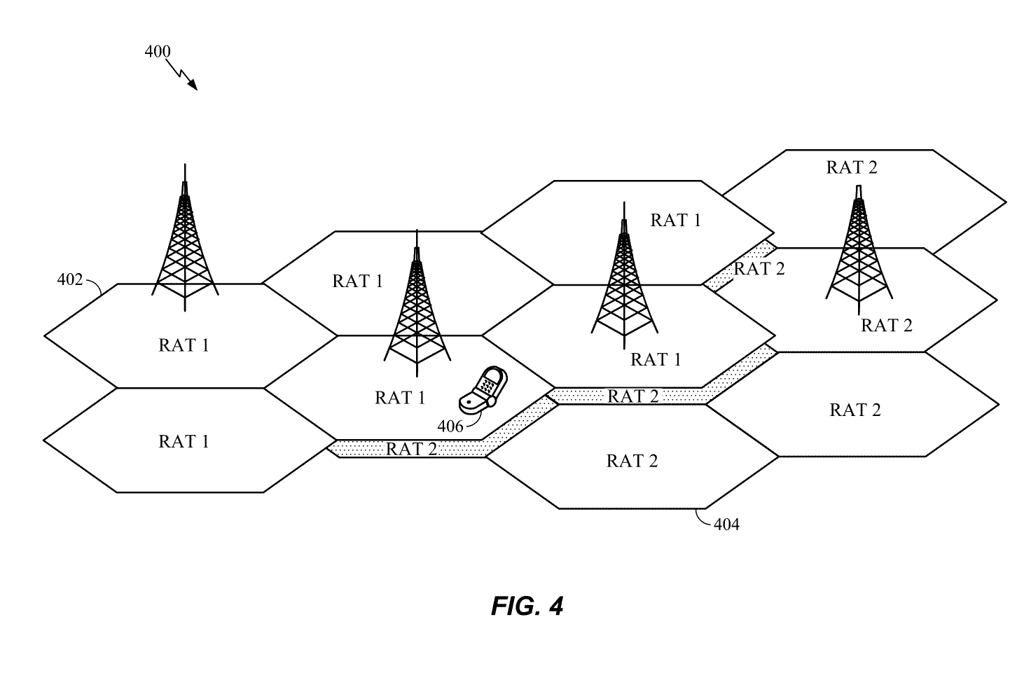

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Redirection from one RAT to another RAT is commonly used to perform operations such as load balancing or circuit switched fallback from one RAT to another RAT. For example, one of the RATs may be long term evolution (LTE) while the other RAT may be universal mobile telecommunications system—frequency division duplexing (UMTS FDD), universal mobile telecommunications system—time division duplexing (UMTS TDD), or global system for mobile communications (GSM). In some aspects, the redirection may be from a frequency or cell of one RAT to a frequency or cell of the same RAT.

CSFB is a feature that enables multimode user equipments (UEs) that are capable of communicating on a first RAT (e.g., LTE) in addition to communicating on a second RAT (e.g., 2G/3G) to obtain circuit switched voice services while being camped on the first RAT. For example, the CSFB capable UE may initiate a mobile-originated (MO) circuit switched voice call while on LTE. Because of the mobile-originated circuit switched voice call, the UE is redirected to a circuit switched capable RAT. For example, the UE is redirected to a radio access network (RAN), such as a 3G or 2G network, for the circuit switched voice call setup. In some instances, the CSFB capable UE may be paged for a mobile-terminated (MT) voice call while on LTE, which results in the UE being moved to 3 G or 2G for the circuit switched voice call setup.

### Fast Return After CSFB Call Release

Aspects of the present disclosure are directed to reducing delays associated with returning to a first radio access technology (RAT) after a redirected circuit switched call back (CSFB) call is released from a second RAT. For example, the first RAT may be a Long Term Evolution (LTE) RAT while the second RAT is a third/second generation (3G/2G) RAT, such as TD-SCDMA or GSM. In one aspect, a user equipment (UE) may be redirected to the second RAT to permit a circuit switched (CS) call or communication.

Upon completion of the circuit switched call, the UE may attempt to return to the first RAT for ongoing or new packet switched calls. In some instances, however, the attempt to return to the first RAT after releasing the CS call on the second RAT fails. As a result, the UE remains on the second RAT and may establish a packet switched call on the second RAT. The packet switched (PS) call may be triggered by a background application that does not affect a user's perception. In this example, the second RAT is a lower priority than the first RAT, for example, because the second RAT is a lower speed RAT.

In one aspect of the disclosure, the UE periodically suspends communications during the packet switched call on the second RAT to create a measurement gap (e.g., a forced measurement gap) to monitor the first RAT. When the UE finds a suitable cell in the first RAT based on the monitoring, the UE returns to the first RAT to resume the packet switched call.

An expedited (or fast) return of the UE to the first RAT network (e.g., packet switched RAT such as LTE) after the completion of the circuit switched voice call is particularly important for high speed data communications. Current 3GPP specifications, however, fail to expedite the return of the UE to the first RAT. According to the current 3GPP specification, the UE uses normal mobility procedures to return to the first RAT. For example, when the UE initiates a call or receives a page, the UE is redirected to the second RAT (e.g., circuit switched RAT such as GSM) and returns to the first RAT after the circuit switched call is completed or released. To return the UE to the first RAT, the second RAT sends redirect information to the UE instructing the UE to return to the first RAT. Optionally, the UE autonomously performs fast return or blind redirection to the first RAT.

Due to mobility of the UE, however, the UE may move out of the first RAT coverage area. As a result, the UE may not detect a good cell of the first RAT when the UE performs a power scan for the first RAT cells. When the UE fails to detect a suitable cell of the first RAT, the UE camps on the second RAT (newly selected or currently serving) directly, or indirectly via 2G to 3G cell reselection. As a result, ongoing or new data communications (e.g., background data calls) may take place on the second RAT network. For example, the UE may set up background packet switched calls in the second RAT (e.g., 2G or 3G network), and remain on the second RAT for the packet switched communications (especially when the signal of the second RAT is strong). The UE may continue to remain on the second RAT, when the second RAT does not support packet switched handover to the first RAT, even while the UE is in a coverage area of a strong cell of the first RAT. Consequently, the user experience is degraded.

Aspects of the present disclosure, expedite the return of the UE to the first network after completion of the circuit switched call at the second network. As noted, when the UE initiates a call or receives a page indicating a call to the UE, the UE is redirected to the circuit switched RAT. After the CSFB call ends, the UE attempts to return to the packet switched RAT. If the return to the packet switched RAT fails, the UE may periodically use a forced measurement gap to monitor the first RAT while camped on the second RAT. For example, the monitoring may be for collecting a system information block (SIB)/master information block (MIB) of the first RAT, searching for cells and/or measuring cells of the first RAT.

In one aspect of the disclosure, the forced measurement gap may be created by periodically suspending communications during a packet switched call on the second RAT. The suspended communications may be packet switched communications, for a background application, established on the circuit switched RAT. The packet switched communications may be established prior to, during or after the release of the circuit switched call. When the UE detects a desirable cell of the first RAT based on the monitoring, the UE may return to the first RAT and continue the packet switched call. In an exemplary configuration, the forced measurement gap occurs for one second every five minutes.

In one aspect of the disclosure, the UE is redirected to a radio access network (RAN) for the circuit switched voice call setup when the UE is in idle mode. For example, the CSFB capable UE may be paged for a mobile-terminated (MT) voice call while the UE is in LTE idle mode, which results in the UE being moved to 3G or 2G for the circuit switched voice call setup.

In other aspects of the disclosure, the UE is in a connected mode. For example, the UE may be engaged in a packet switched call on the first RAT when the UE receives the page for the circuit switched call. As a result, the UE may suspend the ongoing packet switched call on the first RAT to permit the circuit switched call on the second RAT. Upon completion of the circuit switched call on the second RAT, the UE may resume the packet switched call on the first RAT when the UE returns to the first RAT.

In some aspects of the present disclosure, returning to the first RAT from the second RAT entails terminating an ongoing packet switched call on the second RAT. In other words, the terminating occurs when data activities are ongoing. For example, the mode of the second RAT may be changed from a connected mode to an idle mode to effectively terminate communications with the second RAT. When the packet switched communications are for a background application, the user experience is not degraded by the termination.

The return to the first RAT also includes selecting a cell in the first RAT. Selecting the cell in the first RAT may be based on the results of the monitoring of the first RAT. For example, the UE may measure the signal quality of the cells of the first RAT. The UE then resumes the packet switched call on the first RAT.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

In one aspect of the present disclosure, a cell in the first RAT is selected by performing a search, acquisition, system information collection, and confirming a public land mobile network (PLMN) of the cell matches a home PLMN. For example, when the UE detects available first RAT coverage and the detected PLMN matches a PLMN in a subscriber identity module of the UE, the UE sends a signaling connection release indication to the network with cause “to request release of communication with the second RAT.” That is, the UE requests termination of the packet switched data session even when there are ongoing data activities. The UE then enters an idle mode (with or without radio resource control (RRC) connection release from the network) and selects the detected first RAT cell. After establishing a connection with the first RAT, the UE then resumes the data activities with the first RAT. Because the interrupted data session is for a background application, the user experience is not adversely affected.

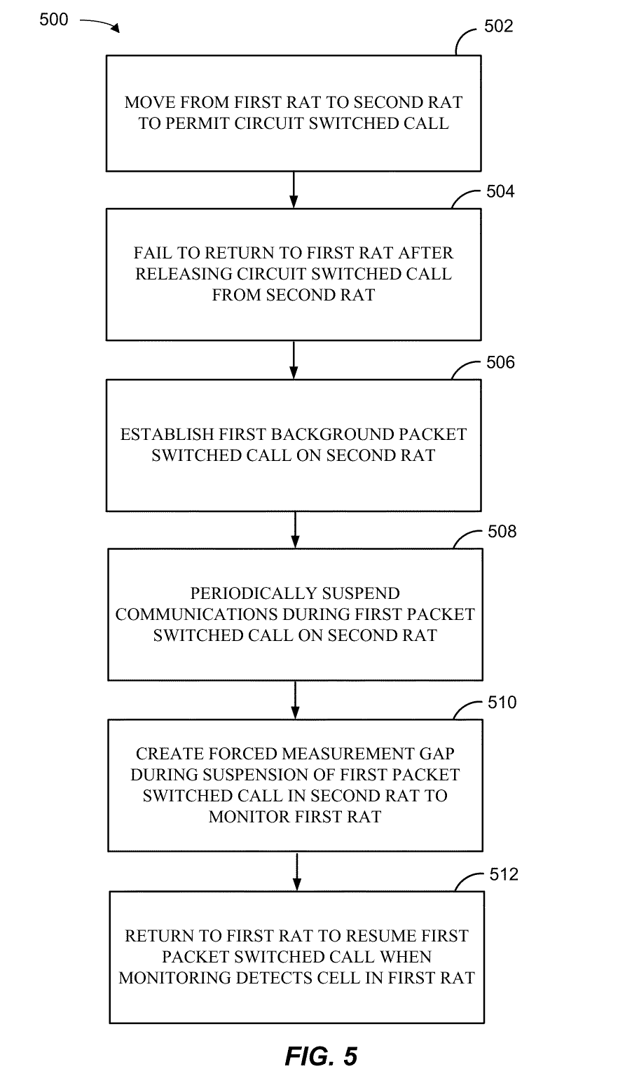

FIG. 5 shows a wireless communication method 500 according to one aspect of the disclosure. A UE moves from a first radio access technology (RAT) to a second RAT to permit a circuit switched (CS) call, as shown in block 502. When the UE fails to return to the first RAT after releasing the CS call on the second RAT, as shown in block 504, the UE establishes a first packet switched (PS) call on the second RAT, as shown in block 506. The UE periodically suspends communications during the first packet switched call on the second RAT, as shown in block 508, to create a forced measurement gap during suspension of the first packet switched call in the second RAT, as shown in block 510. The UE returns to the first RAT to resume the first packet switched call when the monitoring finds a cell in the first RAT.

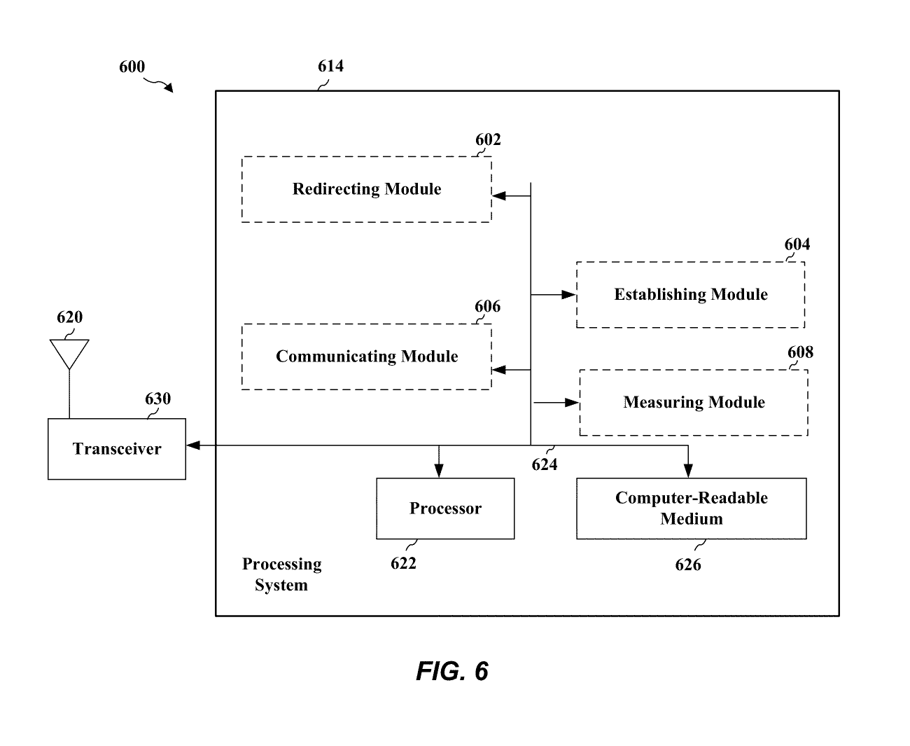

FIG. 6 is a diagram illustrating an example of a hardware implementation for an apparatus 600 employing a redirection return system 614. The redirection return system 614 may be implemented with bus architecture, represented generally by the bus 624. The bus 624 may include any number of interconnecting buses and bridges depending on the specific application of the redirection return system 614 and the overall design constraints. The bus 624 links together various circuits including one or more processors and/or hardware modules, represented by the processor 622 the modules 602, 604, 606, 608 and the non-transitory computer-readable medium 626. The bus 624 may also link various other circuits such as timing sources, peripherals, voltage regulators, and power management circuits, which are well known in the art, and therefore, will not be described any further.

The apparatus includes a redirection return system 614 coupled to a transceiver 630. The transceiver 630 is coupled to one or more antennas 620. The transceiver 630 enables communicating with various other apparatus over a transmission medium. The redirection return system 614 includes a processor 622 coupled to a non-transitory computer-readable medium 626. The processor 622 is responsible for general processing, including the execution of software stored on the computer-readable medium 626. The software, when executed by the processor 622, causes the redirection return system 614 to perform the various functions described for any particular apparatus. The computer-readable medium 626 may also be used for storing data that is manipulated by the processor 622 when executing software.

The redirection return system 614 includes a redirecting module 602 for moving from a first radio access technology (RAT) to a second RAT to permit a circuit switched (CS) call. The redirecting module 602 also identifies when the UE fails to return to the first RAT after releasing the CS call on the second RAT. The redirecting module 602 further returns the UE to the first RAT to resume the first packet switched call when monitoring detects a cell in the first RAT.

The redirection return system 614 includes an establishing module 604 for establishing a first packet switched (PS) call on the second RAT, the first packet switched call triggered by a background application. The redirection return system 614 also includes a communicating module 606 to periodically suspend communications during the first packet switched call on the second RAT. The redirection return system 614 also includes a measuring module 608 for creating a forced measurement gap during suspension of the first packet switched call in the second RAT to monitor the first RAT. The modules may be software modules running in the processor 622, resident/stored in the computer readable medium 626, one or more hardware modules coupled to the processor 622, or some combination thereof. The redirection return system 614 may be a component of the UE 350 and may include the memory 392, and/or the controller/processor 390.

In one configuration, an apparatus such as a UE is configured for wireless communication including means for moving. In one aspect, the moving means may be the antennas 352/520, the receiver 354, the transceiver 530, the channel processor 394, the receive frame processor 360, the receive processor 370, the transmitter 356, the transmit frame processor 382, the transmit processor 380, the controller/processor 390, the memory 392, redirection return module 391, redirecting module 602, and/or the redirection return system 614 configured to perform the aforementioned means. The UE is also configured to include means for identifying a return failure. In one aspect, the identifying means may be the antennas 352/520, the receiver 354, the transceiver 530, the channel processor 394, the receive frame processor 360, the receive processor 370, the transmitter 356, the transmit frame processor 382, the transmit processor 380, the controller/processor 390, the memory 392, redirection return module 391, redirecting module 602, and/or the redirection return system 614 configured to perform the aforementioned means.

The UE is also configured to include means for establishing. In one aspect, the establishing means may be the antennas 352/520, the receiver 354, the transceiver 530, the channel processor 394, the receive frame processor 360, the receive processor 370, the transmitter 356, the transmit frame processor 382, the transmit processor 380, the controller/processor 390, the memory 392, redirection return module 391, establishing module 604, and/or the redirection return system 614 configured to perform the aforementioned means. The UE is also configured to include means for periodically suspending communications. In one aspect, the communications suspending means may be the antennas 352/520, the receiver 354, the transceiver 530, the channel processor 394, the receive frame processor 360, the receive processor 370, the transmitter 356, the transmit frame processor 382, the transmit processor 380, the controller/processor 390, the memory 392, redirection return module 391, communicating module 606, and/or the redirection return system 614 configured to perform the aforementioned means.

The UE is also configured to include means for creating. In one aspect, the creating means may be the antennas 352/520, the receiver 354, the transceiver 530, the channel processor 394, the receive frame processor 360, the receive processor 370, the controller/processor 390, the memory 392, redirection return module 391, measuring module 608, and/or the redirection return system 614 configured to perform the aforementioned means. The UE is also configured to include means for returning. In one aspect, the returning means may be the antennas 352/520, the receiver 354, the transceiver 530, the channel processor 394, the receive frame processor 360, the receive processor 370, the transmitter 356, the transmit frame processor 382, the transmit processor 380, the controller/processor 390, the memory 392, redirection return module 391, redirecting module 602, and/or the redirection return system 614 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE and GSM/TD-SCDMA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication by a user equipment (UE), comprising:
moving from a first radio access technology (RAT) to a second RAT to permit a circuit switched (CS) call;
failing to return to the first RAT after releasing the circuit switched call on the second RAT;
establishing a first packet switched (PS) call on the second RAT, the first packet switched call triggered by a background application;
periodically suspending communications during the first packet switched call on the second RAT;
creating a forced measurement gap during suspending of the first packet switched call in the second RAT to monitor the first RAT; and
returning to the first RAT to resume the first packet switched call when monitoring detects a cell in the first RAT.

2. The method of claim 1, in which the moving occurs when a user equipment is in idle mode on the first RAT.

3. The method of claim 2, further comprising:
suspending a second packet switched call on the first RAT to permit the circuit switched call on the second RAT; and
resuming the second packet switched call when the UE returns to the first RAT.

4. The method of claim 3, in which the returning comprises:
terminating the first packet switched call on the second RAT;
moving to idle mode in the second RAT;
selecting the cell in the first RAT; and
resuming the second packet switched call on the first RAT.

5. The method of claim 4, in which the terminating occurs when data activities are ongoing.

6. The method of claim 4, in which selecting a cell in the first RAT comprises performing a search, acquisition, system information collection, and confirming a public land mobile network (PLMN) of the cell matches a home PLMN.

7. An apparatus for wireless communication by a user equipment (UE), comprising:
means for moving from a first radio access technology (RAT) to a second RAT to permit a circuit switched (CS) call;
means for failing to return to the first RAT after releasing the circuit switched call on the second RAT;
means for establishing a first packet switched (PS) call on the second RAT, the first packet switched call triggered by a background application;
means for periodically suspending communications during the first packet switched call on the second RAT;
means for creating a forced measurement gap during suspending of the first packet switched call in the second RAT to monitor the first RAT; and
means for returning to the first RAT to resume the first packet switched call when monitoring detects a cell in the first RAT.

8. The apparatus of claim 7, in which the moving means further comprises means for moving when a user equipment is in idle mode on the first RAT.

9. The apparatus of claim 8, further comprising:
means for suspending a second packet switched call on the first RAT to permit the circuit switched call on the second RAT; and
means for resuming the second packet switched call when the UE returns to the first RAT.

10. The apparatus of claim 9, in which the returning means comprises:
means for terminating the first packet switched call on the second RAT;
means for moving to idle mode in the second RAT;
means for selecting the cell in the first RAT; and
means for resuming the second packet switched call on the first RAT.

11. The apparatus of claim 10, in which the terminating means further comprises means for terminating when data activities are ongoing.

12. The apparatus of claim 10, in which the selecting means further comprises means for performing a search, means for acquiring, means for collecting system information, and means for confirming a public land mobile network (PLMN) of the cell matches a home PLMN.

13. An apparatus for wireless communication by a user equipment (UE), comprising:
a memory; and
at least one processor coupled to the memory and configured:
to move from a first radio access technology (RAT) to a second RAT to permit a circuit switched (CS) call;
to fail to return to the first RAT after releasing the circuit switched call on the second RAT;
to establish a first packet switched (PS) call on the second RAT, the first packet switched call triggered by a background application;
to periodically suspend communications during the first packet switched call on the second RAT;
to create a forced measurement gap during suspending of the first packet switched call in the second RAT to monitor the first RAT; and
to return to the first RAT to resume the first packet switched call when monitoring detects a cell in the first RAT.

14. The apparatus of claim 13, in which the at least one processor is further configured to move when a user equipment is in idle mode on the first RAT.

15. The apparatus of claim 14, in which the at least one processor is further configured:
to suspend a second packet switched call on the first RAT to permit the circuit switched call on the second RAT; and
to resume the second packet switched call when the UE returns to the first RAT.

16. The apparatus of claim 15, in which the at least one processor is further configured to return by:
terminating the first packet switched call on the second RAT;
moving to idle mode in the second RAT;
selecting the cell in the first RAT; and
resuming the second packet switched call on the first RAT.

17. The apparatus of claim 16, in which the at least one processor is further configured to terminate when data activities are ongoing.

18. The apparatus of claim 16, in which the at least one processor is further configured to select the cell in the first RAT by performing a search, acquisition, system information collection, and confirming a public land mobile network (PLMN) of the cell matches a home PLMN.

19. A computer program product for wireless communication by a user equipment (UE), comprising:
a non-transitory computer-readable medium having program code recorded thereon, the program code comprising:
program code to move from a first radio access technology (RAT) to a second RAT to permit a circuit switched (CS) call;
program code to fail to return to the first RAT after releasing the circuit switched call on the second RAT;
program code to establish a first packet switched (PS) call on the second RAT, the first packet switched call triggered by a background application;
program code to periodically suspend communications during the first packet switched call on the second RAT;
program code to create a forced measurement gap during suspending of the first packet switched call in the second RAT to monitor the first RAT; and
program code to return to the first RAT to resume the first packet switched call when monitoring detects a cell in the first RAT.

20. The computer program product of claim 19, further comprising program code to move when a user equipment is in idle mode on the first RAT.

21. The computer program product of claim 20, further comprising:
program code to suspend a second packet switched call on the first RAT to permit the circuit switched call on the second RAT; and
program code to resume the second packet switched call when the UE returns to the first RAT.

22. The computer program product of claim 21, further comprising program code to return by:
terminating the first packet switched call on the second RAT;
moving to idle mode in the second RAT;
selecting the cell in the first RAT; and
resuming the second packet switched call on the first RAT.

23. The computer program product of claim 22, further comprising program code to terminate when data activities are ongoing.

24. The computer program product of claim 22, further comprising program code to select by performing a search, acquisition, system information collection, and confirming a public land mobile network (PLMN) of the cell matches a home PLMN.
